(19) United States
(12) Patent Application Publication
(10) Pub. No.: US 2011/0179622 A1
(43) Pub. Date: Jul. 28, 2011

(54) Reusable Temporary Aircraft Traffic Safety Markers

(76) Inventor: David Cersonsky, Austin, TX (US)

(21) Appl. No.: 12/692,587

(22) Filed: Jan. 22, 2010

(51) Int. Cl. B23P 11/00

(52) U.S. Cl. 29/428

(57) ABSTRACT

The present embodiment relates to a temporary, portable marker system for directing aircraft traffic while in the air or on the ground. It relates to a marker or markers that have a predetermined shape that conveys information to air or ground traffic, such as an “X”, a “Rectangle”, a “Chevron” or a series or combination thereof, and being sized at least large enough so as to be seen by air or ground traffic. The marker is displayed on a generally horizontal surface in a generally horizontal fashion and may include elements for receiving various fasteners to permit the marker to be strapped to anchors in the ground or other generally horizontal surface which is off of the expected aircraft traveled surface in such a manner as to secure the marker(s) and maintain the marker(s) shape.

### CROSS-REFERENCE TO RELATED APPLICATIONS

None

### FEDERALLY SPONSORED RESEARCH

None

### SEQUENCE LISTING OR PROGRAM

None

### BACKGROUND

1. Field

With the proliferation of aircraft traffic, there is an increased need to create a safe environment for which aircraft traffic can operate in. Runways and taxiways, which are often together referred to as “airport traffic ways.” must often be closed completely or partially to air and ground traffic for periodic maintenance and servicing. When an airport traffic way, or a portion thereof, is closed, the closure must be communicated to air and ground traffic to prevent aircraft traffic from inadvertently accessing the closed area. The closure of an airport traffic way is often identified with the application of a marker or markers to the designated airport traffic way, said markers are relatively large and easy to visualize by air and ground traffic. Although skilled artisans have provided the art with numerous examples of runway/taxiway closure markers, existing markers are either difficult and cumbersome to install, require an excessive amount of time and effort to install, are difficult to construct, or do not incorporate adequate anchoring structure. Given these and other deficiencies in the art, the need for continued improvement in the art of runway/taxiway closures is evident.

This need was made evident to me when in November of 2008 I was being required to temporarily displace the end of a runway for the purpose of doing some construction near that end of the runway. The process required that I place seven sixty-five foot chevron markers on the runway and two rectangle markers just off of the runway to project the message to aircraft that there was a hazard near the end of the runway and, therefore, 700 feet of the runway was not useable. In the essence of time, I did what virtually everyone with this need today does, I purchased readily available plywood and sandbags, painted the plywood, filled the sandbags and had six men place the plywood down in the needed configurations and take up the plywood at the end of the day. This took one and a half hours each day for twenty days. The cost of this was very high and instigated my thoughts of a better way, and so came the idea for this embodiment. I did not apply the idea, but felt that it was a good idea that could be used by others facing the same need. I have since tested the method and it does work.

Accordingly, it is an object of the present embodiment to provide an airport air and ground transportation marker for an airport traffic way.

Another object of the present embodiment is to provide an airport air and ground transportation marker for an airport traffic way that is easy to construct and easy to install relative to an airport traffic way.

Yet another object of the present embodiment is to provide an airport air and ground transportation marker for an airport traffic way that utilizes strapping devices for anchoring the marker in place relative to an airport traffic way, and which provides superior resistance to wind disruption.

A further object of the present embodiment is to provide an airport air and ground transportation marker for an airport traffic way that is durable and easily removed after use.

Yet a further object of the present embodiment is to provide an airport air and ground transportation marker for an airport traffic way that requires no physical modification to the airport traffic way in order to anchor it in place.

Yet still a further object of the present embodiment is to provide an airport air and ground transportation marker for an airport traffic way that requires no fasteners between the marker and the airport traffic way in order to anchor it in place.

Yet another object of the present embodiment is to provide a convenient, reliable, and economical method for closing all or part of runways and taxiway to air and ground airport traffic.

In summary, the intent of the embodiment is to visually inform pilots of existing conditions on or near a runway, taxiway, or other surface during daylight hours. It is designed to satisfy the following directive from the Federal Aviation Administration with regards to temporary marking . . .
“If unable to paint the markings on the pavement, construct them from any of the following materials: double-layered painted snow fence, colored plastic, painted sheets of plywood, or similar materials. They must be properly configured and secured to prevent movement . . . ”

2. Prior Art

Temporary aircraft traffic safety markers that are described in prior art include those made of various materials including fabric, plywood, snow fencing or construction mesh which are held in place with objects such as sand bags, bricks or a water bladder. These materials can be cumbersome to work with, and have problems of the material blowing over or away, curling up, etc., while being placed or after being placed on the surface. They also present an increased danger to aircraft traffic that might come in contact with them. Placement, removing and storing such materials can also be difficult, cumbersome and very time consuming. The difficulty of application of these methods leads to their non-use at times that should require their use and thereby endangering both aircraft and ground personnel.

Prior art covered under U.S. Pat. No. 7,302,908, issued to Bieberdorf in 2007 utilizes a bladder around the perimeter of a marker which must be filled with a fluid for anchoring. The problem with such a design is that water or some other fluid must be available on the runway by one means or another, there is typically no faucet within a short distance of an airway. Therefore, transporting and injecting the fluid into the bladder would require some sort of additional equipment and take time to perform. After the marker is no longer being used, one must expel the fluid, presumably onto the runway which could cause a potentially dangerous unexpected condition.

An application was made with the U.S. Patent Office with the number 0104472 by Nuebert in 2002 for a marker which would be attached directly to the expected aircraft traveled surface. This would damage the surface and require repairs after the marker(s) were removed on what should be an operating runway. An alternative method for attachment described within that publication was to attach the marker to sand bags which would once again presents a hazard to oncoming aircraft.

A high cost option currently available to airports only applicable for closing a runway is a mobile warning light apparatus, such as the one disclosed in U.S. Pat. No. 5,122,797, issued to Wanasz on Jun. 16, 1992. These warning light assemblies are expensive, and must be mounted on a vehicle or trailer in order to be moved and used. The usefulness of a lighted apparatus is questionable since airports can simply turn off the runway or taxiway lights to inform pilots that these areas are closed. In daylight conditions these lighting systems are less visible and dangerous to place in the way of aircraft traffic.

Thus several advantages of one or more aspects of this embodiment are to fulfill a perceived need in airport management for a low cost, safe, effective, and expedient means for visually communicating ground conditions to aircraft traffic during daylight hours. The preferred embodiment excludes elevated obstacles that might damage oncoming aircraft. It is easy to place, affix and remove without damage or alteration to the expected aircraft traveled surface and can be stored easily for emergency and/or future use. These and other advantages of one or more aspects will become apparent from a consideration of the ensuing description and accompanying drawings.

### SUMMARY

My currently preferred embodiment includes one or more reusable temporary aircraft traffic safety markers which are affixed to the desired surface by means of straps that extend to an area that is off of the edge the expected aircraft traveled surface. The straps secure the marker(s) in place and preserve the shape of the marker(s). The result is a clear, highly visible visual communication which excludes elevated hazards that might damage oncoming aircraft. It is easy to place, affix and remove without damage or alteration to the expected aircraft traveled surface. It can be stored easily for emergency and/or future use.

### DRAWINGS

### Figures

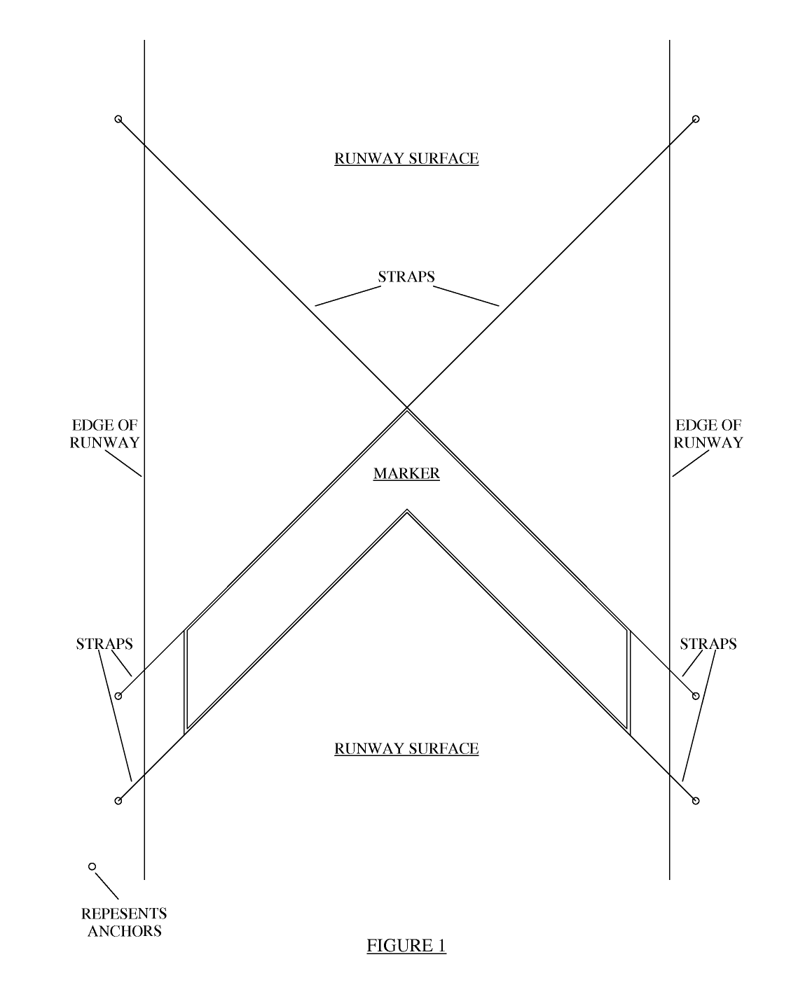

FIG. 1 shows a possible configuration of the preferred embodiment from an overhead perspective of a single marker strapped down on a runway, in this case the marker is a “chevron”, a commonly known visual communication within the art.

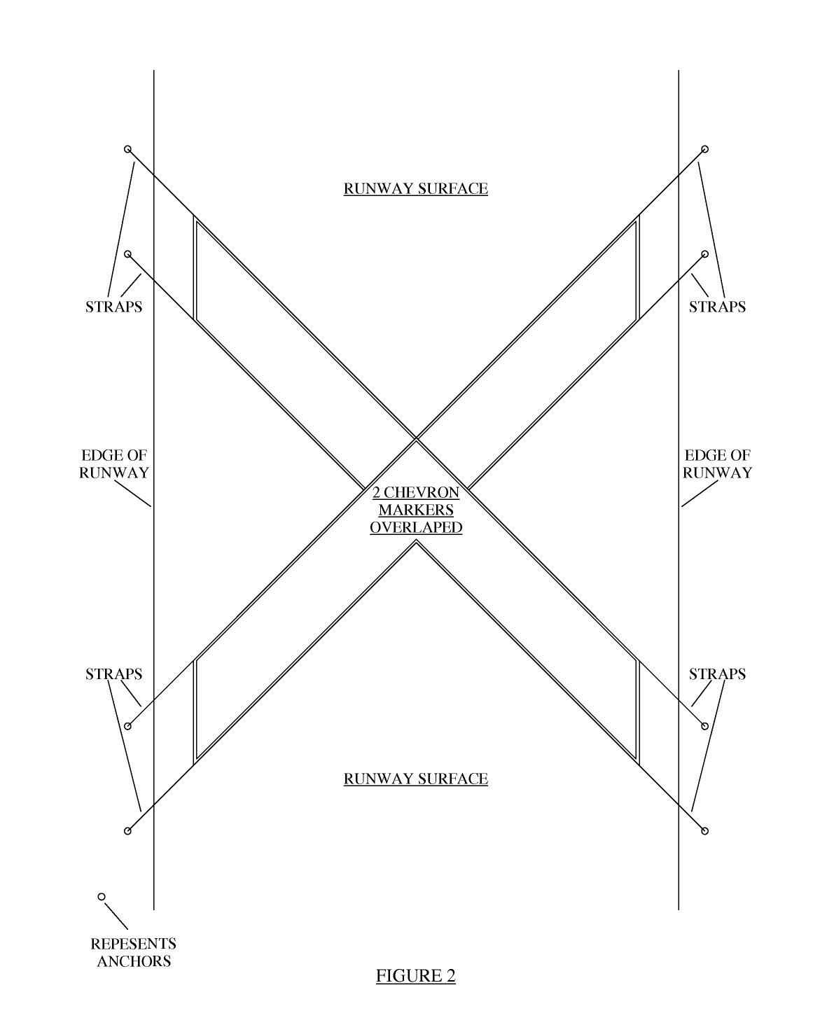

FIG. 2 shows a possible configuration of the preferred embodiment from an overhead perspective of two markers being used in unison, both are chevrons with one chevron having the mirror orientation of that chevron shown in FIG. 1, the two chevrons are strapped down so that the apex of the marker is overlapped to create an “X”, a commonly known visual communication within the art.

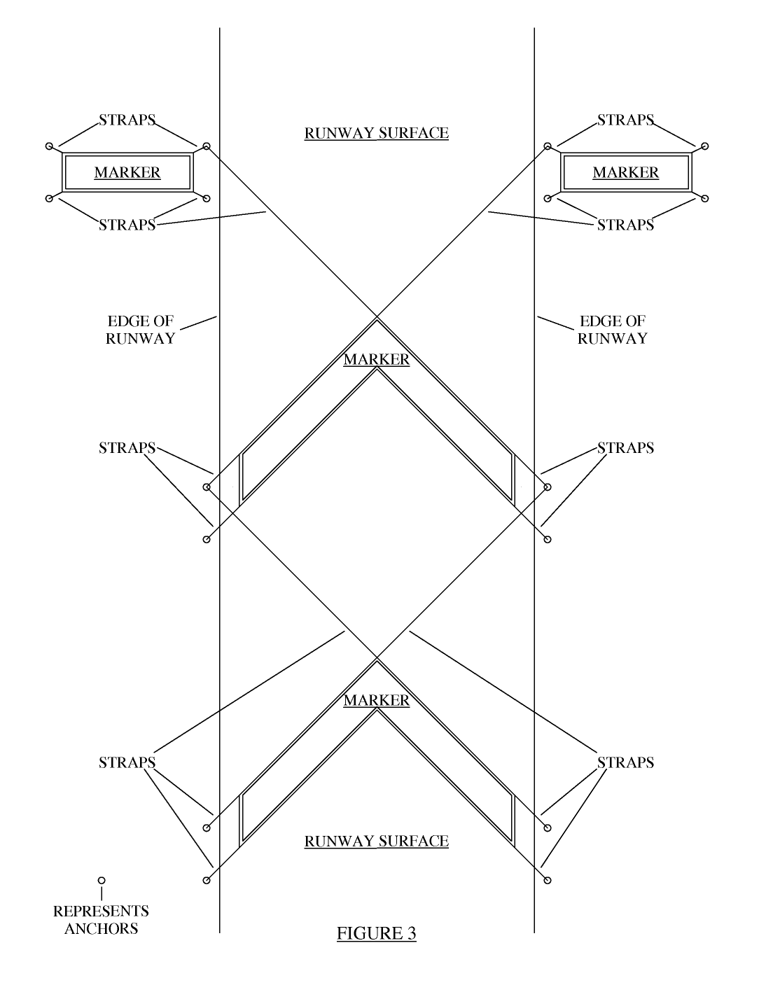

FIG. 3 shows a possible configuration of the preferred embodiment from an overhead perspective of several markers strapped down in series both on and near the runway to create a commonly known visual communication within the art.

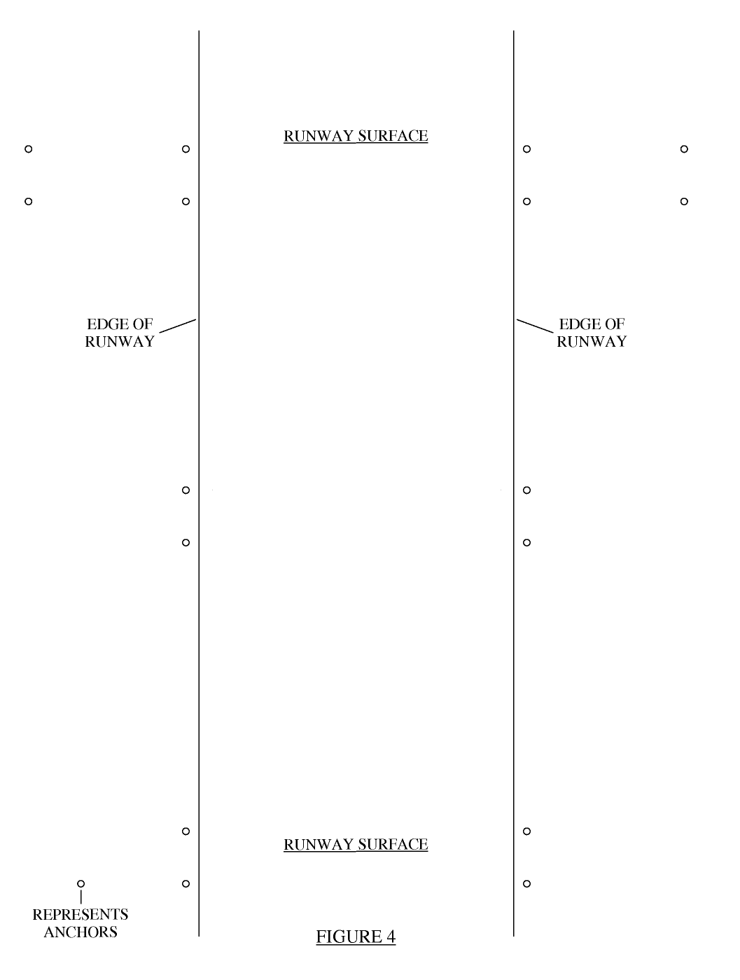

FIG. 4 shows a possible placement of anchors that allows the attachment of any configuration of the preferred embodiment shown in the examples in FIG. 1, 2 or 3.

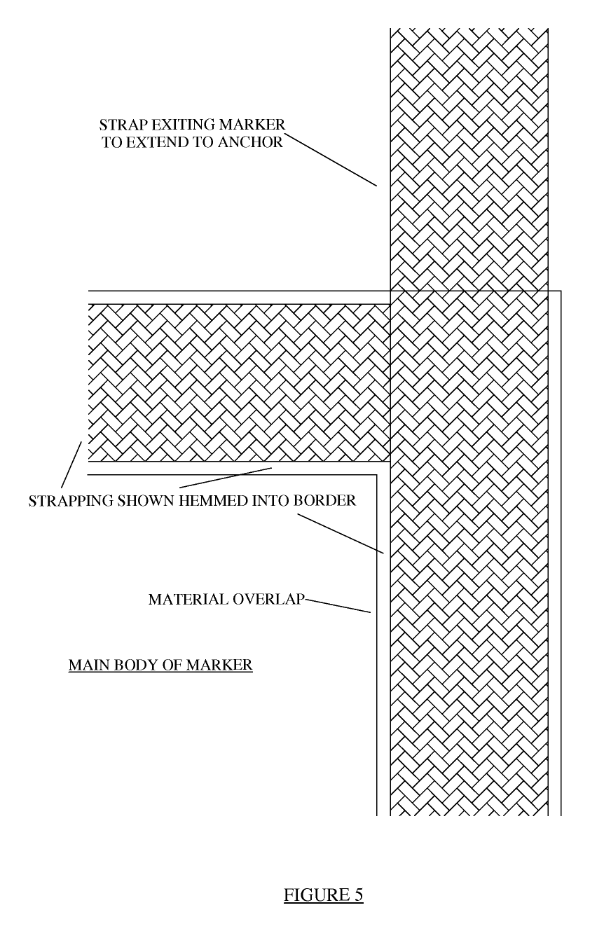

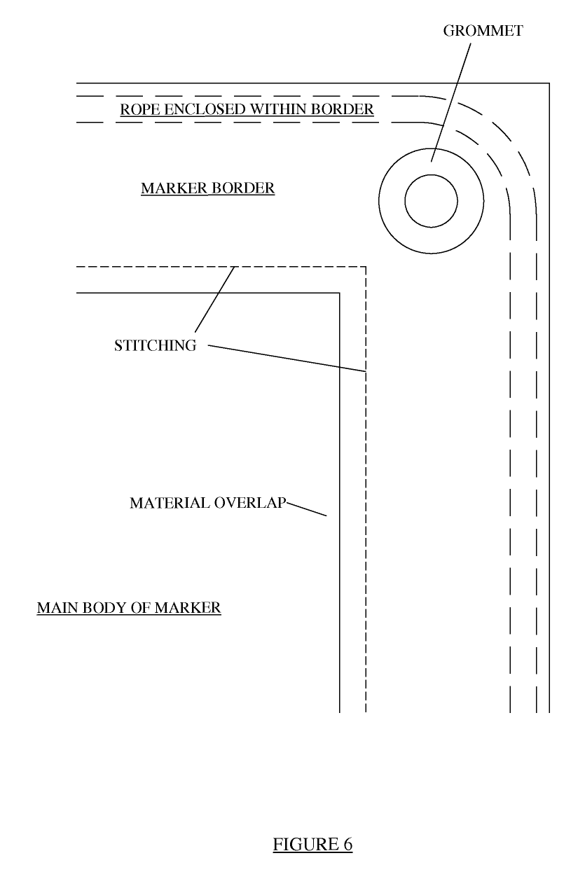

FIG. 5 and FIG. 6 shows two close ups of one corner of the preferred embodiment, depicting two possible construction methods that would satisfy the required elements needed for the preferred embodiment to function. FIG. 5 shows a permanently attached strap and FIG. 6 shows a corner that is designed to accept various types of straps commonly available for use.

### DETAILED DESCRIPTION

FIGS. 1, 2 and 3 show three different possible configurations of the preferred embodiment from an overhead perspective. The marker(s) are strapped down in such a manner as to hold the marker(s) in place and maintain the shape of said marker(s) without altering or damaging the expected travel surface of the aircraft. There are three primary elements that are shown and required for the preferred embodiment to function as designed: 1) the marker itself; 2) a strapping device to connect the marker(s) to the anchors which are located off of the expected aircraft traveled surface; and 3) anchors for the strapping device to attach to. It is preferred that the embodiment be lightweight, strong, highly visible (typically either white or yellow in color) and affected as little as possible by air movement, sunlight and other environmental conditions.

The marker(s) should be made primarily from a material that is selected from the group consisting essentially of fabric, plastic, leather, or metal, and/or a combination thereof. Attention should be given to the weight, strength, color, durability and porosity of the material used to manufacture the marker(s). The marker(s) should further incorporate a border to be located about the perimeter of said marker to add strength and allow for the strapping device to be attached around the edges of said marker.

The strapping device should also be made primarily from a material that is selected from the group consisting essentially of fabric, plastic, leather, or metal, and/or a combination thereof. (most probably in the form of a strap, rope, cable or other commonly known prior art used for attaching one element to another). In addition, the strapping device may include ways of adjusting length and/or tension. It may be appropriate to use a strapping device that incorporates elasticity attributes. The strapping device should be of sufficient strength to secure and maintain the shape of the preferred embodiment. The strapping device should include a mechanism such as a clasp or hook at the end that is attaching to the anchor and then at the other end if it is not permanently attached to the marker. Straps should be visible to aircraft as they approach, but not so visible as to detract from the desired shape of the marker that is needed to create the desired communication when the aircraft is high above the surface.

Anchors can be of a permanent or temporary nature. Because anchors are located off of the expected travel surface of the aircraft, the primary concern should be that they are themselves securely in place so that they will not be pulled out of place by the tension required to hold the marker in place. The anchors need to have an exposed element, such as a hook, ring, dowel or cleat, which will allow the strapping device to securely attach to it. Attention should also be given to whether the anchors, if permanently installed, cause an undesired obstruction for mowing or other equipment that might utilize the place where they are located.

FIG. 4 shows a possible placement of anchors that would allow the attachment of any of the examples of the preferred embodiment shown in FIG. 1, 2 or 3. Anchors could be located differently and may be increased or reduced in number if required to accommodate alternative configurations of the marker(s).

FIG. 5 and FIG. 6 show a close up of a typical outside corner of the marker. Each figure depicts a possible construction method that would satisfy the required elements needed for the preferred embodiment to function. FIG. 5 shows a permanently attached strap and FIG. 6 shows a corner that is designed to accept any one of various types of straps available today. The permanently attached straps would be preferable when the embodiment has been produced specifically for one user and/or circumstance. The method that uses grommets or another receiving device in the corners might be better suited for uses of the embodiment that differ in location from time to time.

### OPERATION

The marker(s) and straps are removed from storage and taken to a location requiring their use. It is then laid out on the surface in more or less the shape that is needed. The straps are then attached from the marker to anchors which are either already in place or installed at that time in the locations that allow the marker to be stretched tightly and held down to the surface in its desired shape. These anchors should be located off of the expected aircraft traveled surface as to not damage or alter said surface. When the need for the embodiment is no longer required, the straps are unhooked from the anchors and the straps and marker(s) are collected off of the surface and returned to storage until they are needed again.

The foregoing is intended to fully teach and disclose the preferred embodiment, but those skilled in the art will readily recognize that the present embodiment can be practiced with various modifications, such as but not limited to, various shapes, sizes, materials, including fabric, leather or metal, various colors, fasteners or elements for receiving fasteners, ground surface anchoring methods and components, etc. Uses could include marker systems for air or ground traffic on ships, roadways, landing pads, and floating docks, which are all well-known in the art without departing from the spirit and scope of the present embodiment.

I claim:

1. A method for attaching a predetermined marker or markers for directing air or ground traffic, comprising the steps of:
a. providing said marker or markers and positioning them on a horizontal surface in a generally horizontal fashion, and
b. wherein said surface is selected from the group consisting essentially of a runway, a taxiway, a roadway, the ground, a ship, a floating dock or a landing pad, and
c. attaching straps to said marker or markers, and
d. attaching the other end of said straps to anchors which are set off of said surface as to not alter or damage said surface,
whereby said marker or markers are stretched tightly in opposing directions and held in such a manner as to preserve said marker or markers in a desired shape and location until no longer needed at which time they can be easily removed.
